(19) United States
(12) Patent Application Publication
(10) Pub. No.: US 2026/0170541 A1
(43) Pub. Date: Jun. 18, 2026

(54) COMPONENT MANAGEMENT SYSTEM, MANAGEMENT SYSTEM, COMPONENT MANAGEMENT METHOD, AND COMPONENT MANAGEMENT PROGRAM

(71) Applicant: MITSUBISHI HEAVY INDUSTRIES, LTD., Tokyo (JP)

(72) Inventors: Sotaro Yamaguchi, Tokyo (JP); Masahiko Taniguchi, Tokyo (JP); Takashi Aizawa, Tokyo (JP); Eiji Yoshioka, Tokyo (JP); Takayuki Umeno, Tokyo (JP); Akihiro Toda, Tokyo (JP); Atsuto Kobayashi, Tokyo (JP)

(73) Assignee: MITSUBISHI HEAVY INDUSTRIES, LTD., Tokyo (JP)

(21) Appl. No.: 18/715,960

(22) PCT Filed: Dec. 12, 2022
(86) PCT No.: PCT/JP2022/045731

§ 371 Date: Jun. 3, 2024

(30) Foreign Application Priority Data
Dec. 13, 2021 (JP) 2021-201929

(51) Int. Cl. G06Q 30/0601; G06Q 10/20

(52) U.S. Cl. CPC G06Q 30/0611; G06Q 30/0633; G06Q 10/20

(57) ABSTRACT

Provided are a component management system, a management system, a component management method, and a component management program with which it is possible to perfectly manage components. This component management system (60) comprises: a service life estimation unit (72) for estimating the remaining lifetime of a component of interest on the basis of a use state, such as use time, of the component of interest; and a quotation request unit (62) that, on the basis of the remaining lifetime and a delivery period set in advance as the period required for the delivery of the component of interest, issues request for a quotation for the component of interest when the remaining lifetime has become shorter than or equal to the delivery period.

### Technical Field The present disclosure relates to a part management system, a management system, a part management method, and a part management program.

### BACKGROUND ART

A solid fuel such as a biomass fuel or coal is pulverized into a fine powder within a predetermined grain size range by a pulverizer (hereinafter, referred to as a “mill”), and is fed to combustion equipment. In the mill, the solid fuel put into a pulverizing table is sandwiched and pulverized between the pulverizing table and a pulverizing roller, and a pulverized fuel within a predetermined grain size range, of the solid fuel pulverized into fine powder, is sorted by a classifier, and the pulverized fuel is transported to a boiler by a carrier gas (primary air) that is supplied from an outer periphery of the pulverizing table to be combusted in the combustion equipment. In a thermal power plant, steam is generated by heat exchange with a combustion gas produced by combusting pulverized fuel in a boiler, and a steam turbine is rotationally driven by the steam to rotationally drive a generator connected to the steam turbine, whereby electric power generation is performed.

As described above, the mill is a device that pulverizes, dries, and classifies solid fuel. For this reason, regular maintenance such as replacement of parts (rollers, pulverizing tables, and the like) worn during operation is required. In addition, since a fatigue service life exists in a rotating portion such as a bearing (particularly, a rolling bearing), the rotating portion cannot be used for an infinite period. The rotating portion also requires regular maintenance. As the maintenance, for example, time-based maintenance (TBM) performed based on a usage time is performed. In addition, condition-based maintenance (CBM) performed based on the inspection result may be performed. Regular maintenance is required not only for the mill but also for various devices.

PTL 1 describes that the operation status of the device is monitored to determine the maintenance inspection schedule. PTL 2 describes that a quote is created based on a quotation database when an order placement request e-mail is received.

### CITATION LIST

### Patent Literature

[PTL 1] Japanese Unexamined Patent Application Publication No. 2001-7597

[PTL 2] Japanese Unexamined Patent Application Publication No. 2002-374362

### SUMMARY OF INVENTION

### Technical Problem

The part has a usable service life from a performance aspect or a safety aspect, and a part that has exceeded the service life is considered for replacement. It is necessary for a user (device user or the like) to request a quotation or place an order for a target part to a manufacturer (device manufacturer or the like). However, it may be difficult for the user to appropriately manage the parts and request a quotation or place an order in an appropriate time. When a quotation request or an order placement is delayed, the manufacturer may not have a sufficient preparation period required for delivery, and there is a possibility that a part may be used far beyond its service life without being able to replace the part in an appropriate time. If a part that has significantly exceeded the service life is used, there is a possibility that required performance may not be obtained, or other parts may be damaged, and thus, the safe operation of the device may be affected. It is required to appropriately manage the parts.

In PTL 1 and PTL 2, a manufacturer's preparation period is not taken into consideration, and there is room that the manageability of the parts can be further improved.

The present disclosure has been made in view of such circumstances, and an object thereof is to provide a part management system, a management system, a part management method, and a part management program capable of appropriately managing parts.

### Solution to Problem

A first aspect of the present disclosure is a part management system including a service life estimation unit that estimates a remaining lifetime of a target part according to a use state of the target part, and a quotation request unit that issues a quotation request for the target part, based on the remaining lifetime and a delivery period set in advance as a period required for delivery of the target part.

A second aspect of the present disclosure is a part management method including a step of estimating a remaining lifetime of a target part according to a use state of the target part, and a step of issuing a quotation request for the target part, based on the remaining lifetime and a delivery period set in advance as a period required for delivery of the target part.

A third aspect of the present disclosure is a part management program causing a computer to execute a process of estimating a remaining lifetime of a target part according to a use state of the target part, and a process of issuing a quotation request for the target part, based on the remaining lifetime and a delivery period set in advance as a period required for delivery of the target part.

### Advantageous Effects of Invention

According to the present disclosure, there is an effect that a part can be appropriately managed.

### BRIEF DESCRIPTION OF DRAWINGS

FIG. 1 s a diagram showing a schematic configuration of a part management system according to an embodiment of the present disclosure.

FIG. 2 shows a configuration example of a management system according to an embodiment of the present disclosure.

FIG. 3 is a functional block diagram showing functions included in the part management system according to the embodiment of the present disclosure.

FIG. 4 is a diagram showing a specific example of the part management function according to the embodiment of the present disclosure.

FIG. 5 is a diagram showing a specific example of the quotation request function according to the embodiment of the present disclosure.

FIG. 6 is a diagram showing a specific example of the electronic part list function according to the embodiment of the present disclosure.

FIG. 7 is a diagram showing a specific example of the document management function according to the embodiment of the present disclosure.

FIG. 8 is a diagram showing a specific example of the data analysis function according to the embodiment of the present disclosure.

FIG. 9 is a schematic configuration diagram showing an example of a hardware configuration included in the part management system according to an embodiment of the present disclosure.

FIG. 10 is a flowchart showing an example of procedure to deal with the process according to the embodiment of the present disclosure.

FIG. 11 is a configuration diagram showing a solid fuel pulverizing device and a boiler according to an embodiment of the present disclosure.

### DESCRIPTION OF EMBODIMENTS

Hereinafter, an embodiment of a part management system, a management system, a part management method, and a part management program according to the present disclosure will be described with reference to the drawings.

### Entire Configuration of System

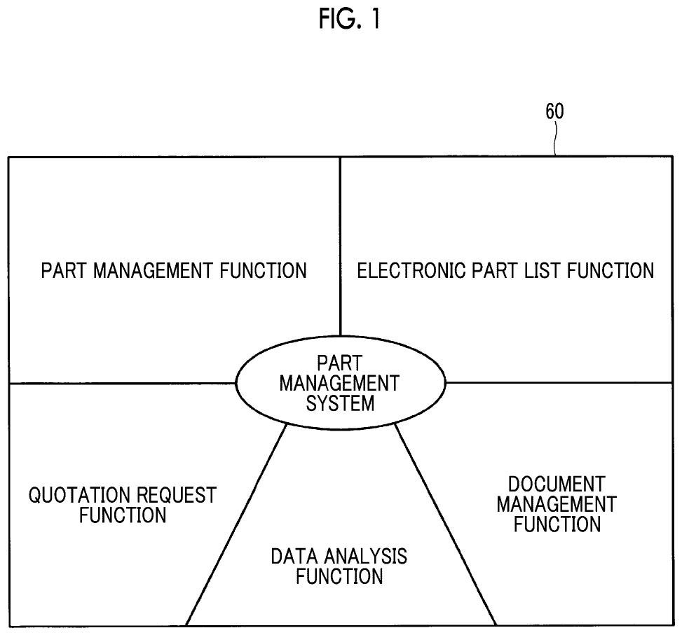

FIG. 1 is a diagram showing a schematic configuration of a part management system 60 according to an embodiment of the present disclosure. As shown in FIG. 1, the part management system 60 according to the present embodiment has a part management function, a quotation request function, an electronic part list function, a document management function, and a data analysis function. The part management system 60 is a system provided to a user for part management, for example, by a manufacturer.

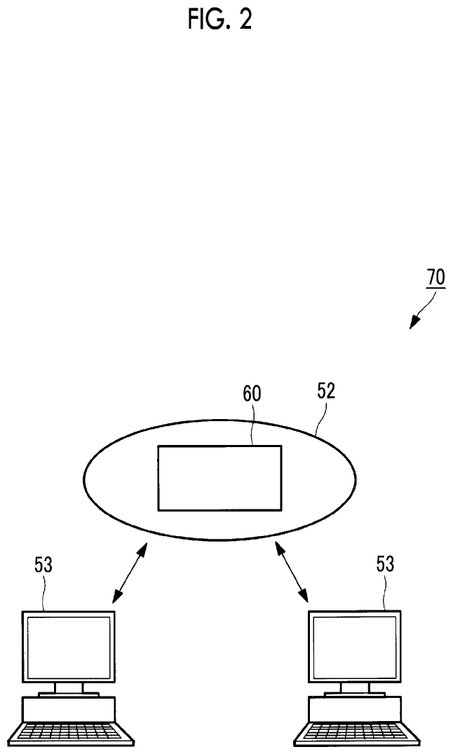

FIG. 2 shows a configuration example of a management system 70 including the part management system 60. As shown in FIG. 2, the information processing terminal 53 is connected to the network. For example, the information processing terminal 53 is provided for each of the user and the manufacturer. A server 52 installed on a cloud or a user side is connected to the network, and can communicate with the information processing terminal 53. The server 52 has various functions of the part management system 60. Using the information processing terminal 53, it is possible to access the part management system 60 of the server 52 and browse or input various types of information. The location of each function is not limited to the case where the server 52 has the function, and can be changed.

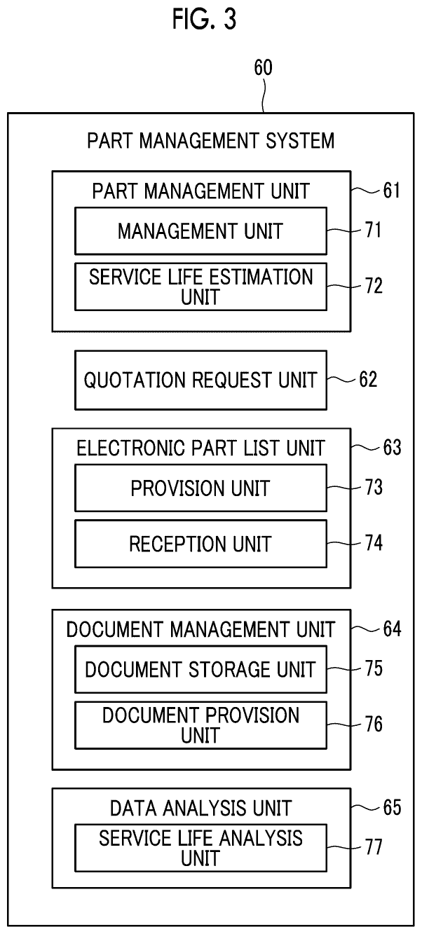

FIG. 3 is a functional block diagram showing functions included in the part management system 60. As shown in FIG. 3, the part management system 60 includes a part management unit 61, a quotation request unit 62, an electronic part list unit 63, a document management unit 64, and a data analysis unit 65.

### Part Management Function

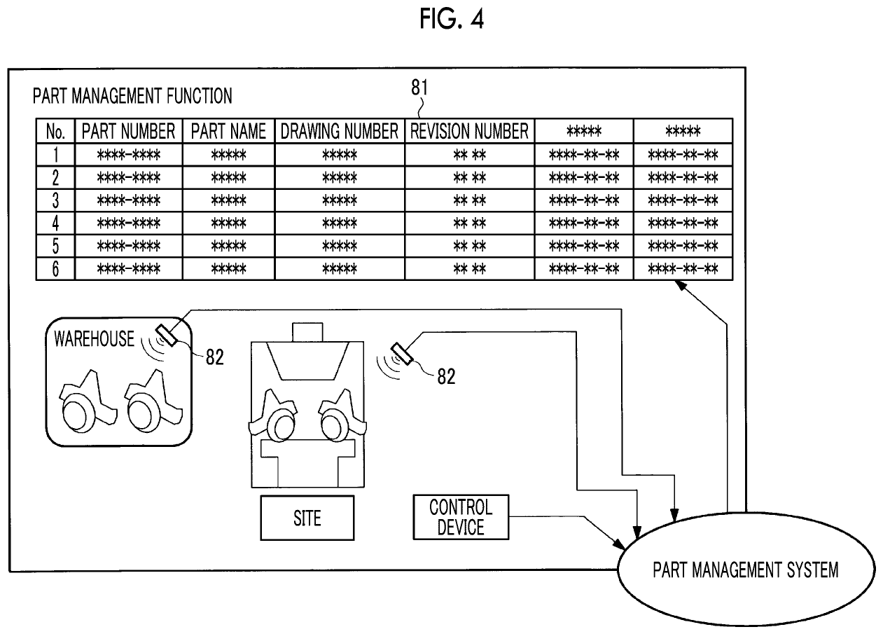

The part management unit 61 has a part management function. FIG. 4 is a diagram showing a specific example of the part management function in FIG. 1. £ The part management unit 61 manages various types of information about the parts or products delivered to the user. As shown in FIG. 3, the part management unit 61 includes a management unit 71 and a service life estimation unit 72.

The management unit 71 associates at least one of the product information, the order information, the location information, and the time information with each part and creates a database to manage the information (for example, reference numeral 81 in FIG. 4). Target parts for which remaining lifetime estimation is performed for quotation request are also included in the parts. A part (target part) may include a spare part stored in a warehouse or the like by a user for replacement in addition to a part currently used. By associating various types of information with the part, various types of information about the part held by the user are organized.

The product information is information relating to a product (part), and is information including at least one of a part name, a part number, a drawing number, and a revision number. The part name is the name of the part, and is set by a manufacturer, for example. The part number is a unique number corresponding to the part. The drawing number is a drawing number of the part. The revision number is a number indicating the number of times of revision added to the drawing number when the drawing is revised.

The order information is information related to an order (arrangement), and is information including at least one of order content information (order information) and an order number. The order content information is information about the order content of the part. The order number is a number related to an order of the part. For example, the order information is transcribed and registered from the order data when the manufacturer receives an order for a product (part).

The location information is information relating to a location where the part (actual article) is present, and is information including at least one of a usage location and a storage location. The usage location is information relating to a location where the part is actually used. The usage location may be, for example, information about a device in which the part is used. The storage location is information about a location where the part is actually stored without being used. The location information may be manually registered, or a transmitter such as an RFID may be provided in the part, and the location of each part may be acquired by a receiver (for example, reference numeral 82 in FIG. 4). In this case, for example, a signal including the unique number of the part may be received from the RFID to determine that the part is present in the vicinity of the receiver that has received the signal.

The time information is information related to a time, and is information including at least one of a delivery time, a use start time, a storage start time, service life information, and delivery period information. The delivery time is a time when the part is delivered to the user. The use start time is a time when the use of the part is started. The storage start time is a time when the storage of the part is started. The service life information is information about the service life (standard service life) of the part. The delivery period information is information about the delivery period (standard delivery period) of the part. The service life information and the delivery period information are set by, for example, a manufacturer.

The management unit 71 can also manage the information other than the above in association with the part.

In particular, in the management unit 71, it is preferable that the usage location and the usage time (operation time) are associated with the part. The usage time may be the usage time of the single part or may be the usage time of the device in which the part is used. The usage time may be acquired from, for example, a control device of the corresponding device.

The service life estimation unit 72 estimates the remaining lifetime of the target part according to the use state of the target part. The use state is, for example, information managed by the management unit 71, and is, for example, a usage time (operation time). If the remaining lifetime can be estimated, the other information can also be used as the use state. The remaining lifetime is a remaining time until a service life (limit value of usage time) set in advance with respect to the part.

Specifically, the service life estimation unit 72 acquires the service life (standard service life) of the target part and the usage time from the management unit 71, and calculates the remaining lifetime by subtracting the usage time from the service life. The method for estimating the remaining lifetime is not limited to the above. In this way, the maintenance of the TBM part can be ensured.

### Quotation Request Function

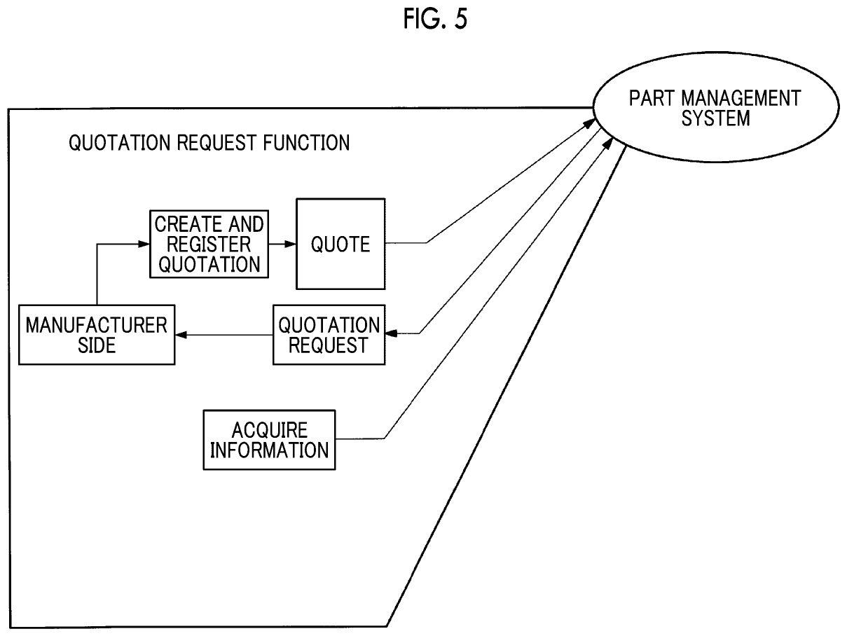

The quotation request unit 62 has a quotation request function. FIG. 5 is a diagram showing a specific example of the quotation request function in FIG. 1. The quotation request unit 62 issues a quotation request for the target part. Specifically, as shown in FIG. 5, various types of information are acquired from the part management unit 61 or the like, and a quotation request is automatically issued to the manufacturer. The manufacturer creates and registers a quotation using the issued quotation request as a trigger, and creates a quote as data. The created quote is sent to the user. The created quotation may be sent to the user through an agent or the like without going through the part management system 60, if necessary. In addition to the quotation request, at least one of quotation creation, registration, and sending may be automated.

Specifically, the quotation request unit 62 issues a quotation request for the target part, based on the remaining lifetime and the delivery period (delivery period information) set in advance as the period required for delivery of the target part. Specifically, the delivery period is a period from when the manufacturer receives an order to when the manufacturer delivers the part to the user, and includes a period required for design, material arrangement, production, transportation, and the like in the manufacturer, or a part thereof. It is preferable that the quotation request unit 62 starts a process such that the quotation request is issued in the time before the delivery period from a time when the remaining lifetime of the target part becomes 0.

The quotation request unit 62 issues a quotation request in a case where the remaining lifetime is equal to or less than the delivery period. That is, the remaining lifetime is reduced by use, and the quotation request is automatically issued in the time when the delivery period set in advance is exceeded. Accordingly, a period for a delivery period can be secured until the end of the service life.

It is preferable that the quotation request unit 62 acquires information about whether or not to issue a quotation request when acquiring various types of information from the part management unit 61 or the like. For example, in a case where the quotation request has already been issued in the time when the remaining lifetime of the target part is equal to or less than the delivery period, the quotation request unit 62 can prevent the quotation request from being duplicated by holding off (or canceling) the automatic issuance of the quotation request. In addition, the quotation request unit 62 may issue an e-mail inquiring about the progress of the work such as the creation status of the quotation to the manufacturer instead of the quotation request.

Issuing a quotation request is, for example, a process of issuing (transmitting) a quotation request to a manufacturer. The user may be notified of the content of the quotation request issued to the manufacturer. The manufacturer performs a quotation work based on the quotation request, and creates a quote. In a case where an existing quotation system is present in the manufacturer, the instruction may be sent to the quotation system to create a quotation. Since the quotation request is automatically issued by the quotation request unit 62, it is preferable that the quotation request (the quotation request form) explicitly indicates that the quotation request is automatically issued by the part management system 60.

The quotation request includes, for example, information such as product information to be quoted (part number, part name, drawing number, and the like), a required quantity, and a delivery date.

The time of issuing the quotation request is not limited to the above. For example, a period (preparation period) relating to a quotation work, an order placement work, or the like may be considered in addition to the delivery period. In this case, the quotation request unit 62 issues the quotation request in a case where the remaining lifetime is equal to or less than a period obtained by adding the delivery period, the quotation period, and the order placement period (arrangement period) (delivery period+quotation period+order placement period). The quotation period is a period set in advance as a period required for creating a quotation, and is a period from a quotation request to sending of the quotation to the user (a necessary period for a manufacturer). The order placement period is a period set in advance as a period for placing an order for the presented quotation, and is a period from when the quotation is sent to the user to when the order is placed (a necessary period for the user). In this manner, the quotation request can be issued with sufficient time.

In addition, the budget application time of the user may be taken into consideration. The budget application time is a time when the user applies for the maintenance cost to be generated in a certain period (generally, the next fiscal year) the future as the budget in the company, and is set in advance for each user. By considering the budget application time, it is possible to suppress a problem such as a budget shortage due to a budget application omission for the replacement of the parts. In this case, the quotation request unit 62 issues a quotation request in a time of the budget application time for the user, that is, in a case where a time obtained by subtracting, from the remaining lifetime, a period obtained by adding the delivery period, the quotation period, and the order placement period (delivery period+quotation period+order placement period) is earlier than the next budget application time. The time of the budget application time is the arrival time of the set budget application time. In a case where a period is set as the budget application time, it is also possible to set the time within the budget application time (period). That is, in the time of the budget application time, that is, in a case where the time obtained by subtracting, from the remaining lifetime, the period (delivery period+quotation period+order placement period) is earlier than the next budget application time, in a time when the next budget application time arrives, it is assumed that the remaining lifetime is not as long as the period required for the delivery period or the like. Therefore, it is possible to more reliably secure the budget by issuing the quotation request at the current budget application time.

The delivery period, the quotation period, and the order placement period are set in advance, but can be changed according to the business situation of the user or the manufacturer (whether or not the user or the manufacturer is busy and the like).

### Electronic Part List Function

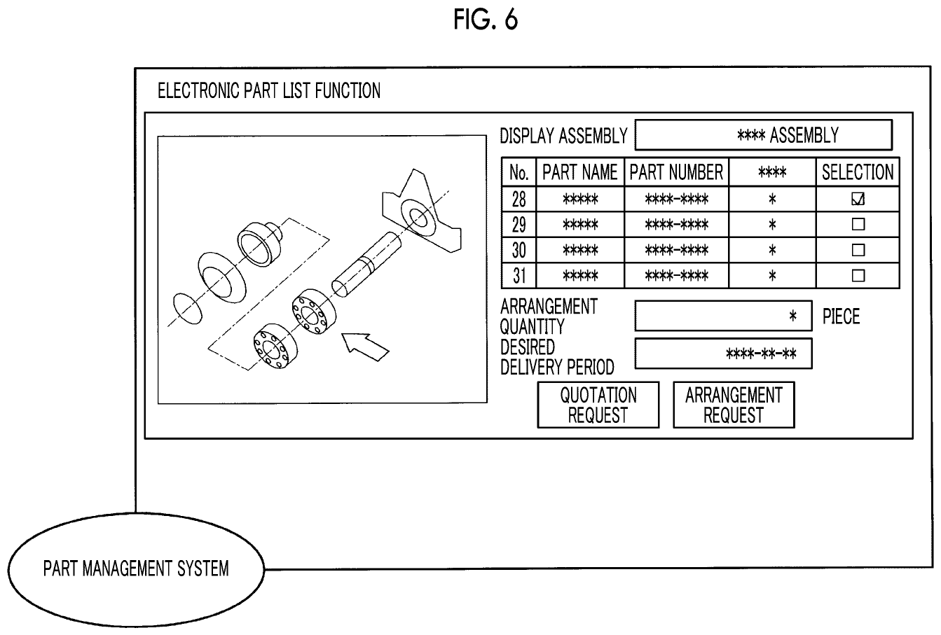

The electronic part list unit 63 has an electronic part list function. FIG. 6 is a diagram showing a specific example of the electronic part list function in FIG. 1. The electronic part list unit 63 provides a list (electronic part list) of various parts. As shown in FIG. 3, the electronic part list unit 63 includes a provision unit 73 and a reception unit 74.

The provision unit 73 provides information about the part being delivered. That is, the list data of the parts is provided to the user so that the user can confirm each part information. For example, the information is provided by displaying the information about each part on the information processing terminal 53 on the user side. The user can select the part by operating the information processing terminal 53. As for the display of the parts, as shown in FIG. 6, the information about the part may be narrowed down in a hierarchical order from a large configuration. That is, the information about the part is associated in a hierarchical order from a large configuration (a group of a plurality of parts) to a small configuration (a group of a smaller number of parts than the large configuration). For example, the hierarchy is divided in the order of boiler unit selection, mill serial number selection, assembly Selection, sub-assembly selection, sub-sub-assembly selection, and part selection. It is preferable that the choices are easily imagined by using a bird's-eye view or a 3D view. The displayed drawing may not show an exact shape of the product, and may show a general shape of the product. In addition, it is preferable that the screen for selecting the part also displays the installation position of the part to be understood using an exploded view. In the selection of the part, the part in the exploded view may be directly clicked, or a number or the like assigned to the part may be clicked. When the part is selected, it is desirable that information such as the “part name”, “part number”, “drawing number”, “weight”, “number of uses”, and “unit” of the part can be confirmed.

The user can access the part being delivered on the system and can confirm the information. The information about the provided part may be linked to, for example, a system on the manufacturer side. That is, it is preferable that the information about the part is updated to the latest state.

The reception unit 74 receives an order (a quotation request or an arrangement request) for the part, based on the information provided by the provision unit 73. The user can place an order for the part on the system. The order is placed by operating the information processing terminal 53 on the user side. The order may be placed (arrangement request) or may be an order for a quotation request. For example, the cart function is provided, and a part can be selected to be put into the cart to place an order. Other information such as the number of parts or a desired delivery period may be settable. When the order is placed, the order content (for example, the quotation request) is transmitted to the manufacturer.

### Document Management Function

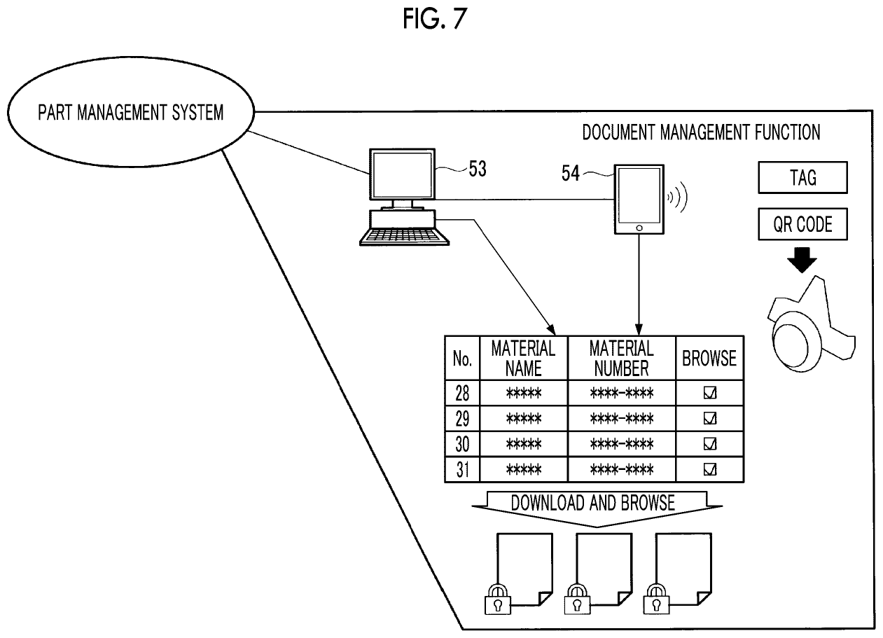

The document £ management unit 64 has a document management function. FIG. 7 is a diagram showing a specific example of the document management function in FIG. 1. The document management unit 64 manages electronic data of a document related to various parts. As shown in FIG. 3, the document management unit 64 includes a document storage unit 75 and a document provision unit 76.

The document storage unit 75 stores electronic data of a document related to the part being delivered. That is, the document storage unit 75 has document data such as a drawing and a user manual. a case where a revision of a document such as a modification of a drawing occurs, it is preferable that the electronic data is updated to the latest information. In the document, it is preferable that attribute information (for example, “drawing number” (may be a material number), “revision number”, “name” (material name), “revision date”, and the like) is registered together with the electronic data.

The document provision unit 76 provides, in response to a browsing request for the stored document, electronic data of the corresponding document. For example, in a case where a document of a certain part is selected (that is, a browsing request) by an operation of the information processing terminal 53 on the user side, the electronic data of the document of the part is displayed (browsed) on the information processing terminal 53 on the user side to provide the data. When a browsing request is made, the document data may be downloaded from the server 52 installed on the cloud or the manufacturer side. In addition, a tag such as an RFID, or a QR code (registered trademark) may be attached to the product, and the tag or the QR code (registered trademark) may be read by an information terminal to display a list H documents related to the product. The search function may be used to narrow down the document. From the viewpoint of information management, it is preferable that a log is left in a case where various processes such as browsing, downloading, copying, and printing of a document are performed.

### Data Analysis Function

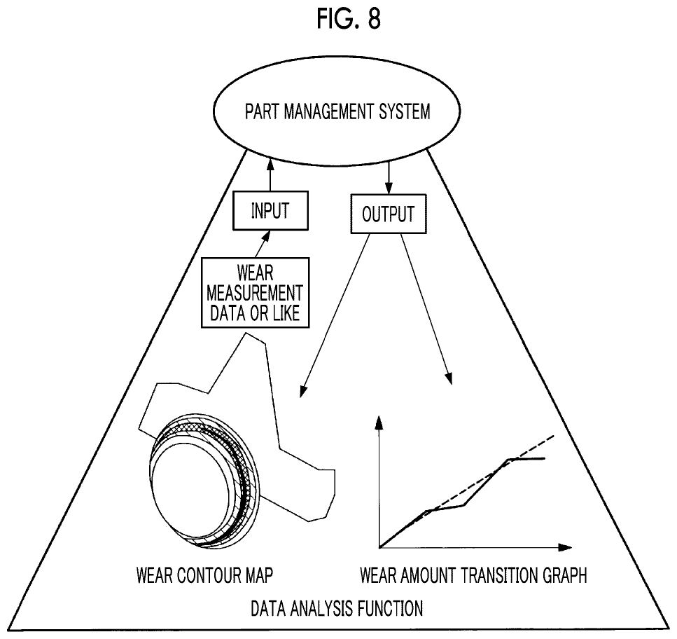

The data analysis unit 65 has a data analysis function. FIG. 8 is a diagram showing a specific example of the data analysis function in FIG. 1. The data analysis unit 65 performs data analysis based on the input data. In particular, the remaining lifetime is estimated by performing data analysis. For this reason, the data analysis unit 65 includes a service life analysis unit 77.

The service life analysis unit 77 estimates the remaining lifetime of the target part based on the measurement data related to the target part. For example, when the product (part) is inspected by the user or the manufacturer and the measurement data is registered as the inspection result, the remaining lifetime is analyzed. Examples of the measurement data include the measurement data of the wear amount of the pulverizing roller 13 of the mill. A graph of the wear amount transition is created by associating the input wear amount and the operation time of the device, and the remaining lifetime until the wear reaches a predetermined upper limit value can be estimated from the approximate straight line or the approximate curve. A wear contour map (a map showing a current shape of the pulverizing roller 13 based on the measurement data of wear amount) may be output. By comparing the output wear contour maps over time, it is possible to visually grasp the progress status of the wear. The measurement data is not limited to the wear amount data, and other parameters can also be used.

When the remaining lifetime is estimated by the service life analysis unit 77, the quotation request unit 62 issues a quotation request for the target part, based on the remaining lifetime based on the measurement data and the delivery period, as described above. In this manner, it is also possible to request a quotation for the part that is the CBM target.

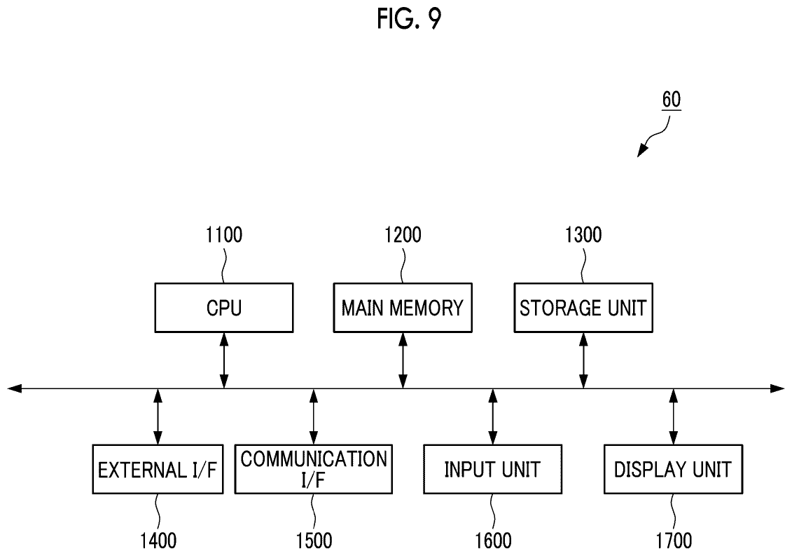

FIG. 9 is a schematic configuration diagram showing an example of a hardware configuration included in the part management system 60 according to an embodiment of the present invention. The same applies to the hardware configuration of the information processing device. As shown in FIG. 9, the part management system 60 is a so-called computer, and includes a central processing unit (CPU) 1100, a main memory 1200, a storage unit 1300, an external interface 1400, a communication interface 1500, an input unit 1600, and a display unit 1700, for example. The respective units are directly or indirectly connected to each other via a bus, and perform various processes in cooperation with each other.

For example, the CPU 1100 controls the whole part management system 60 using an operating system (OS) stored in the storage unit 1300 connected via a bus, and performs various processes by executing various programs stored in the storage unit 1300.

For example, the main memory 1200 includes a writable memory such as a cache memory or a random-access memory (RAM), and is used as a work region for reading an execution program of the CPU 1100 and writing processing data of the execution program.

The storage unit 1300 is a non-transitory computer readable storage medium, and is, for example, a read-only memory (ROM), a hard disk drive (HDD), a flash memory, or the like. The storage unit 1300 stores, for example, an OS for controlling the entire device such as Windows (registered trademark), iOS (registered trademark), and Android (registered trademark), a basic input/output system (BIOS), various device drivers for hardware operation of peripheral devices, various types of application software, various data, files, and the like. In addition, the storage unit 1300 stores a program for realizing various processes and various data required for realizing various processes.

The external interface 1400 is an interface for connecting external device. Examples of the external device include an external monitor, a USB memory, and an external HDD. In the example shown in FIG. 9, only one external interface is shown. However, a plurality of external interfaces may be provided.

The communication interface 1500 functions as an interface for transmitting and receiving information by being connected to a network and communicating with other devices.

For example, the communication interface 1500 communicates with other devices, for example, in a wired or wireless manner. Examples of wireless communication include Bluetooth (registered trademark), Wi-Fi, and communication using a dedicated communication protocol. As an example of wired communication, a wired local area network (LAN) may be used.

For example, the input unit 1600 is a user interface for giving an instruction, such as a keyboard, a mouse, or a touch pad.

For example, the display unit 1700 is a liquid-crystal display or an organic electroluminescence (EL) display. In addition, the display unit 1700 may be a touch panel display on which a touch panel is superimposed.

For example, each of the above-described functions is realized by a processing circuitry. For example, a series of processes for realizing functions described below are stored in the storage unit 1300 in a form of a program, as an example. The CPU 1100 reads the program into the main memory 1200, and executes information processing and calculation processing to realize various functions.

A form in which the program is installed in advance in the storage unit 1300, a form in which the program is provided in a state of being stored in another computer-readable storage medium, or a form in which the program is distributed via wired or wireless communication means may be applied. The computer-readable storage medium is a magnetic disk, a magneto-optical disk, a CD-ROM, a DVD-ROM, a semiconductor memory, or the like.

### Flow of Process Using Part Management System

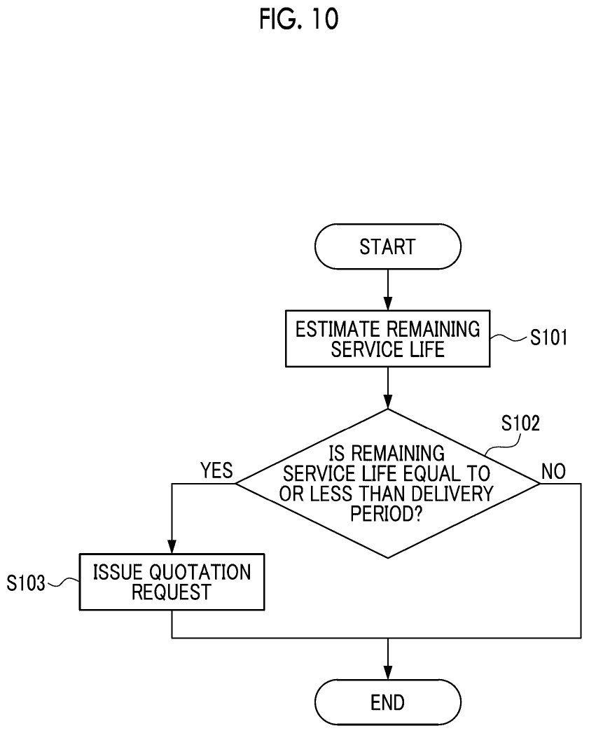

Next, an example of a quotation request process performed by the above-mentioned part management system 60 will be described with reference to FIG. 10. FIG. 10 is a flowchart showing an example of procedure for the quotation request process according to the present embodiment. The flow shown in FIG. 10 is repeatedly executed, for example, in a predetermined control cycle. It is preferable that the management unit 71 be updated with the latest information.

First, the remaining lifetime is estimated based on the information managed by the management unit 71 (S101). Specifically, in a case where the service life estimation unit 72 performs process, the remaining lifetime is calculated by subtracting the usage time from the service life. In addition, in a case where the service life analysis unit 77 performs process, the remaining lifetime is estimated based on the measurement data.

Next, it is determined whether or not the remaining lifetime is equal to or less than the delivery period (S102). In S102, the quotation period or the like may be considered as described above, or the budget application time may be considered.

In a case where the remaining lifetime is not equal to or less than the delivery period (NO determination in S102), the process ends.

In a case where the remaining lifetime is equal to or less than the delivery period (YES determination in S102), the quotation request is issued (S103). The issued quotation request is sent to the manufacturer.

In this way, the time of issuing a quotation request is determined in consideration of the delivery period set in advance. Accordingly, a period for a delivery period can be secured until the end of the service life, and maintenance can be appropriately performed. Therefore, the parts can be appropriately managed.

### Configuration of Power Plant

Next, an example of the power plant 1 to which the part management system 60 is applied will be described. The part management system 60 can be applied to each part used in, for example, the power plant 1.

A power plant 1 according to the present embodiment includes a solid fuel pulverizing device 100 and a boiler 200.

In the following description, the word “upper” indicates a vertically upper side, and “upper” in an upper portion, an upper surface, or the like indicates a portion on the vertically upper side. Further, similarly, “lower” indicates a portion on the vertically lower side, and a vertical direction is not exact and includes an error.

The solid fuel pulverizing device 100 of the present embodiment is a device that pulverizes solid fuel such as biomass fuel or coal, as an example, to generate pulverized fuel, and feeds the pulverized fuel to a burner (combustion equipment) 220 of the boiler 200.

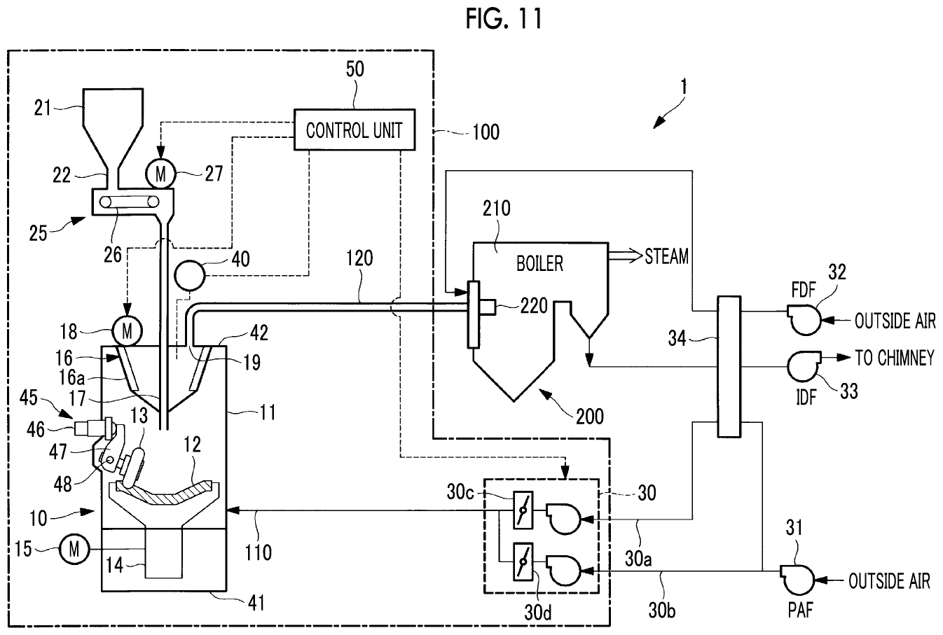

Although the power plant 1 that includes the solid fuel pulverizing device 100 and the boiler 200 shown in FIG. 11 includes a single solid fuel pulverizing device 100, a system may be adopted in which a plurality of solid fuel pulverizing devices 100 are provided respectively corresponding to a plurality of burners 220 of a single boiler 200.

The solid fuel pulverizing device 100 of the present embodiment includes a mill (a pulverizing unit) 10, a bunker (storage unit) 21, a coal feeder (a fuel feeder) 25, a fan unit (a carrier gas supply unit) 30, a state detecting unit 40, and a control unit 50.

The mill 10 that pulverizes solid fuel such as coal or biomass fuel to be fed to the boiler 200 into pulverized fuel, which is finely powdered solid fuel, may be of a type of pulverizing only coal, a type of pulverizing only biomass fuel, or a type of pulverizing biomass fuel together with coal.

Here, the biomass fuel is a renewable organic resource derived from living organisms, and is, for example, thinned wood, waste wood, driftwood, grass, waste, sludge, tires, recycled fuel (pellets or chips) made using these as raw materials, or the like. However, it is not limited to those presented here. Since the biomass fuel takes in carbon dioxide during a growth process of biomass, it is considered to be carbon-neutral because it does not emit carbon dioxide that is a global warming gas. Therefore, various uses thereof are being considered.

The mill 10 includes a housing 11, a pulverizing table 12, a pulverizing roller 13, a gear (drive transmission unit) 14, a mill motor (drive part) 15 that is connected to the gear 14 and that rotationally drives the pulverizing table 12, a rotary classifier (classifying unit) 16, a coal feed pipe (fuel feed unit) 17, and a classifier motor 18 that rotationally drives the rotary classifier 16.

The housing 11 is a casing that is formed in a tubular shape extending in the vertical direction and that accommodates the pulverizing table 12, the pulverizing roller 13, the rotary classifier 16, and the coal feed pipe 17.

The coal feed pipe 17 is mounted to a central portion of a ceiling 42 of the housing 11. The coal feed pipe 17 is for feeding the solid fuel led from a bunker 21 via the coal feeder 25 into the housing 11, and is disposed along an up-down direction at a center position of the housing 11, and a lower end portion thereof extends to the inside of the housing 11.

The gear 14 is installed in the vicinity of a bottom face 41 of the housing 11, and the pulverizing table 12 that is rotated by a driving force that is transmitted from the mill motor 15 connected to the gear 14 is disposed to be rotatable.

The pulverizing table 12 is a circular member when viewed in a plan view, and is disposed such that the lower end portion of the coal feed pipe 17 faces the pulverizing table 12. The upper surface of the pulverizing table 12 may have, for example, an inclined shape in which a central portion is low and it becomes higher toward the outer side to form a shape in which an outer peripheral portion is bent upward. The coal feed pipe 17 feeds solid fuel (in the present embodiment, for example, coal or biomass fuel) from above toward the pulverizing table 12 below, and the pulverizing table 12 pulverizes the fed solid fuel by sandwiching the solid fuel between the pulverizing table 12 and the pulverizing roller 13.

When the solid fuel is put from the coal feed pipe 17 toward a central portion of the pulverizing table 12, the solid fuel is led toward the outer periphery side of the pulverizing table 12 by a centrifugal force due to the rotation of the pulverizing table 12, and is sandwiched and pulverized between the pulverizing table 12 and the pulverizing roller 13. The pulverized solid fuel is blown upward by a carrier gas (hereinafter, referred to as primary air) led from a carrier gas channel 110 (hereinafter, referred to as a primary air channel), and is led to the rotary classifier 16.

A discharge outlet (not shown) that allows the primary air flowing in from the primary air channel 110 to flow out to a space above the pulverizing table 12 in the housing 11 is provided at the outer periphery of the pulverizing table 12. A swirl blade (not shown) is installed at the discharge outlet to impart a swirling force to the primary air blown out from the discharge outlet. The primary air with the swirling force imparted thereto by the swirl blade becomes an air flow having a swirling velocity part, and transports the solid fuel pulverized on the pulverizing table 12 to the rotary classifier 16 on the upper side in the housing 11. The solid fuel larger than a predetermined grain size, of the pulverized solid fuel, is classified by the rotary classifier 16, or falls to be returned to the pulverizing table 12 without reaching the rotary classifier 16 and pulverized between the pulverizing table 12 and the pulverizing roller 13 again.

The pulverizing roller 13 is a rotating body that pulverizes the solid fuel fed from the coal feed pipe 17 onto the pulverizing table 12. The pulverizing roller 13 is pressed against the upper surface of the pulverizing table 12 and pulverizes the solid fuel in cooperation with the pulverizing table 12.

Although only one pulverizing roller 13 is shown as a representative in FIG. 11, a plurality of pulverizing rollers 13 are disposed at constant intervals in a circumferential direction to press the upper surface of the pulverizing table 12. For example, three pulverizing rollers 13 are disposed at equal intervals in the circumferential direction at angular intervals of 120° on an outer peripheral portion. In this case, the portions (pressing portions) where the three pulverizing rollers 13 are in contact with the upper surface of the pulverizing table 12 are equidistant from a rotation central axis of the pulverizing table 12.

The pulverizing roller 13 can be swung and displaced up and down by a journal head 45 and is supported to be movable toward and away from the upper surface of the pulverizing table 12. When the pulverizing table 12 rotates in a state where an outer peripheral surface of the pulverizing roller 13 is in contact with the solid fuel on the upper surface of the pulverizing table 12, the pulverizing roller 13 receives a rotational force from the pulverizing table 12 and rotates together with the pulverizing table 12. When the solid fuel is fed from the coal feed pipe 17, the solid fuel is pressed and pulverized between the pulverizing roller 13 and the pulverizing table 12. The pressing force is referred to as a pulverizing load.

A support arm 47 of the journal head 45 is supported by a supporting shaft 48 along a horizontal direction at an intermediate portion of the support arm 47 such that the pulverizing roller 13 can swing and displace in the up-down direction with the supporting shaft 48 as a center at a side surface portion of the housing 11. Further, a pressing device (pulverizing load application unit) 46 is provided at an upper end portion of the support arm 47 on the vertically upper side. The pressing device 46 is fixed to the housing 11 and applies a pulverizing load to the pulverizing roller 13 through the support arm or the like to press the pulverizing roller 13 against the pulverizing table 12. The pulverizing load is applied, for example, by a hydraulic cylinder (not shown) that is operated by a pressure of hydraulic oil supplied from a hydraulic device (not shown) installed outside the mill 10. In addition, the pulverizing load may be applied by a repulsive force of a spring (not shown).

The gear 14 is connected to the mill motor 15 and transmits the driving force of the mill motor 15 to the pulverizing table 12 to rotate the pulverizing table 12 around the central axis.

The rotary classifier (classifying unit) 16 is provided at an upper portion of the housing 11 and has a hollow and inverted conical outer shape. The rotary classifier 16 has, at positions on an outer periphery thereof, a plurality of blades 16a extending in the up-down direction. The blades 16a are provided at predetermined intervals (equal intervals) around the central axis of the rotary classifier 16.

The rotary classifier 16 is a device that classifies the solid fuel (hereinafter, the pulverized solid fuel is referred to as “pulverized fuel”) pulverized by the pulverizing table 12 and the pulverizing roller 13 into fuel larger than a predetermined grain size (for example, a range of 70 to 100 μm in coal) (hereinafter, the pulverized fuel exceeding a predetermined grain size is referred to as “coarse powder fuel”) and fuel equal to or smaller than the predetermined grain size (hereinafter, the pulverized fuel equal to or smaller than the predetermined grain size is referred to as “pulverized fuel”). The rotary classifier 16 is provided with a rotational driving force by the classifier motor 18 that is controlled by the control unit 50 to rotate around the coal feed pipe 17 with a cylindrical shaft (not shown) extending in the up-down direction of the housing 11 as a center.

As the classifying unit, a fixed classifier having a fixed hollow inverted conical casing and a plurality of fixed swirl blades instead of the blades 16a at positions on an outer periphery of the casing may be used.

The large-diameter powder fuel of the pulverized fuel that reaches the rotary classifier 16 is knocked down by the blade 16a due to the relative balance between a centrifugal force generated by the rotation of the blade 16a and a centripetal force caused by the primary air flow, and returned to the pulverizing table 12 to be pulverized again, and the pulverized fuel is led to an outlet port 19 in the ceiling 42 of the housing 11. The pulverized fuel classified by the rotary classifier 16 is discharged together with the primary air from the outlet port 19 to a pulverized fuel feed channel (pulverized fuel feed pipe) 120 and fed to the burner 220 of the boiler 200.

The coal feed pipe (fuel feed unit) 17 is mounted such that the lower end portion thereof extends to the inside of the housing 11 along the up-down direction to penetrate the ceiling 42 of the housing 11, and feeds the solid fuel put from the upper portion of the coal feed pipe 17 to the central portion of the pulverizing table 12. A coal feeder 25 is connected to an upper end of the coal feed pipe 17, and the solid fuel is fed.

The coal feeder 25 is connected to the bunker 21 by a downspout part 22 which is a tube extending in the up-down direction from the lower end portion of the bunker 21. A valve (coal gate, not shown) for switching the discharge state of the solid fuel from the bunker 21 may be provided in the middle of the downspout part 22. The coal feeder 25 includes a transport unit 26 and a coal feeder motor 27. The transport unit 26 is, for example, a belt conveyor, and transports the solid fuel discharged from a lower end portion of a downspout part 22 to the upper portion of the coal feed pipe 17 by means of a driving force of the coal feeder motor 27, and puts the solid fuel into the coal feed pipe 17. The amount of solid fuel that is fed to the mill 10 is controlled by a signal from the control unit 50, for example, by adjusting the moving speed of the belt conveyor of the transport unit 26.

Normally, the primary air for transporting the pulverized fuel to the burner 220 is supplied to the inside of the mill 10, and the pressure of the primary air is higher than the pressure in the coal feeder 25 or the bunker 21. The fuel is in a laminated state inside the downspout part 22 connecting the bunker 21 and the coal feeder 25. The solid fuel layer ensures the sealing property (material seal) for suppressing the backflow of the primary air and the pulverized fuel from the mill 10 toward the bunker 21.

The fan unit 30 is a device that blows the primary air for drying the pulverized fuel and transporting the pulverized fuel to the rotary classifier 16 to the inside of the housing 11.

In order to appropriately adjust the flow rate and temperature of the primary air that is blown to the inside of the housing 11, in the present embodiment, the fan unit 30 includes a primary air fan (PAF) 31 and a hot gas flow path 30a, a cold gas flow path 30b, a hot gas damper 30c, and a cold gas damper 30d.

In the present embodiment, the hot gas flow path 30a supplies part of the air sent from the primary air fan 31 as a hot gas heated by passing through an air preheater (heat exchanger) 34. The hot gas damper 30c is provided in the hot gas flow path 30a. The degree of opening of the hot gas damper 30c is controlled by the control unit 50. The flow rate of the hot gas that is supplied from the hot gas flow path 30a is determined by the degree of opening of the hot gas damper 30c.

The cold gas flow path 30b supplies part of the air sent from the primary air fan 31 as a cold gas having room temperature. The cold gas damper 30d is provided in the cold gas flow path 30b. The degree of opening of the cold gas damper 30d is controlled by the control unit 50. The flow rate of the cold gas that is supplied from the cold gas flow path 30b is determined by the degree of opening of the cold gas damper 30d.

In the present embodiment, the flow rate of the primary air is the sum of the flow rate of the hot gas that is supplied from the hot gas flow path 30a and the flow rate of the cold gas that is supplied from the cold gas flow path 30b, and the temperature of the primary air is determined by the mixing ratio of the hot gas that is supplied from the hot gas flow path 30a and the cold gas that is supplied from the cold gas flow path 30b, and is controlled by the control unit 50.

Further, for example, part of a combustion gas discharged from the boiler 200 by a gas recirculation fan (not shown) may be led to the hot gas that is supplied from the hot gas flow path 30a to form a mixture, thereby adjusting oxygen concentration in the primary air that is blown to the inside of the housing 11 from the primary air channel 110. By adjusting the oxygen concentration in the primary air, for example, in a case where a solid fuel having high ignitability (easy to ignite) is used, it is possible to suppress the solid fuel from igniting in a passage from the mill 10 to the burner 220.

In the present embodiment, the state detecting unit 40 of the mill 10 transmits measured or detected data to the control unit 50. The state detecting unit 40 of the present embodiment is, for example, differential pressure measuring means, and measures the differential pressure between the pressure at a portion where the primary air flows from the primary air channel 110 to the inside of the housing 11, and the pressure at the outlet port 19 where the primary air and the pulverized fuel are discharged from the inside of the housing 11 to the pulverized fuel feed channel 120, as differential pressure in the mill 10. The increase or decrease in the differential pressure in the mill 10 corresponds to the increase or decrease in the amount of pulverized fuel circulating between the vicinity of the rotary classifier 16 inside the housing 11 and the vicinity of the pulverizing table 12 due to the classification effect of the rotary classifier 16. That is, since the amount and grain size range of pulverized fuel that is discharged from the outlet port 19 can be adjusted by adjusting the rotation speed of the rotary classifier 16 according to the differential pressure in the mill 10, the amount of pulverized fuel corresponding to the amount of solid fuel fed to the mill 10 can be stably fed to the burner 220 provided in the boiler 200 while maintaining the grain size of the pulverized fuel within a range that does not affect the combustibility of the solid fuel in the burner 220.

Further, the state detecting unit 40 of the present embodiment is, for example, temperature measuring means, and detects the temperature of the primary air that is supplied to the inside of the housing 11 (mill inlet primary air temperature) or the temperature of the mixed gas of the primary air and the pulverized fuel in the outlet port 19 (mill outlet primary air temperature), and controls the fan unit 30 not to exceed the respective upper limit temperatures. Each upper limit temperature is determined in consideration of the possibility of ignition according to the characteristics of the solid fuel. The primary air is cooled by transporting the pulverized fuel while drying the pulverized fuel inside the housing 11. Therefore, the primary air temperature at the mill inlet ranges, for example, from room temperature to about 300 degrees, and the primary air temperature at the mill outlet ranges, for example, from room temperature to about 90 degrees.

The control unit 50 is a device that controls each part of the solid fuel pulverizing device 100.

The control unit 50 may transmit a drive instruction to, for example, the mill motor 15 to control the rotation speed of the pulverizing table 12.

The control unit 50 can transmit a drive instruction to, for example, the classifier motor 18 to control the rotation speed of the rotary classifier 16, thereby adjusting the classification performance, and stably feed the pulverized fuel to the burner 220 in an amount corresponding to the feed amount of the solid fuel to the mill 10 while maintaining the grain size of the pulverized fuel within a range that does not affect the combustibility of the solid fuel in the burner 220.

Further, the control unit 50 can transmit a drive instruction to, for example, the coal feeder motor 27 to adjust the amount of solid fuel (coal feed amount) that is fed to the mill 10.

Further, the control unit 50 can transmit an instruction for degree of opening to the fan unit 30 to control the degrees of opening of the hot gas damper 30c and the cold gas damper 30d, thereby adjusting the flow rate and temperature of the primary air. Specifically, the control unit 50 controls the degrees of opening of the hot gas damper 30c and the cold gas damper 30d such that the flow rate of the primary air that is supplied to the inside of the housing 11 and the temperature of the primary air at the outlet port 19 (mill outlet primary air temperature) become predetermined values set corresponding to the coal feed amount for each type of solid fuel. The control of the temperature of the primary air may be performed with respect to the temperature (mill inlet primary air temperature) at the mill inlet.

For example, the control unit 50 is configured to include a central processing unit (CPU), a random-access memory (RAM), a read-only memory (ROM), and a computer-readable storage medium. Since a series of processing for realizing various functions are stored in a storage medium or the like in the form of a program by way of example, various functions are realized in a case where the CPU reads the program on the RAM or the like and executes information processing and calculation processing. A form where a program is installed in a ROM or other storage mediums in advance, a form where a program is provided in a state where the program is stored in a computer-readable storage medium, a form where a program is delivered through wired or wireless communication means, and the like may be applied to the program. The computer-readable storage medium is a magnetic disk, a magneto-optical disk, a CD-ROM, a DVD-ROM, a semiconductor memory, or the like. Further, the HDD may be replaced with a solid-state disk (SSD) or the like.

Next, the boiler 200 that generates steam by combusting the pulverized fuel fed from the solid fuel pulverizing device 100 will be described. The boiler 200 includes a furnace 210 and the burner 220.

The burner 220 is a device that forms a flame by combusting pulverized fuel by using the mixed gas of the pulverized fuel that is fed from the pulverized fuel feed channel 120 and the primary air, and secondary air that is supplied by heating air (outside air) sent from a forced draft fan (FDF) 32 in the air preheater 34. The combustion of the pulverized fuel is performed in the furnace 210, and a high-temperature combustion gas is discharged to the outside of the boiler 200 after passing through a heat exchanger (not shown) such as an evaporator, a superheater, or an economizer.

The combustion gas discharged from the boiler 200 is subjected to a predetermined treatment by an environmental device (a denitration apparatus, a dust collection device, a desulfurization apparatus, or the like) (not shown), heat exchange with the primary air or the secondary air is performed by the air preheater 34, and the combustion gas is led to a chimney (not shown) through an induced draft fan (IDF) 33 and released to the outside air. The air sent from the primary air fan 31, which is heated by the combustion gas in the air preheater 34, is supplied to the hot gas flow path 30a described above.

Feed water to each heat exchanger of the boiler 200 is heated in an economizer (not shown), and further heated by an evaporator (not shown) and a superheater (not shown) to generate high-temperature and high-pressure superheated steam, and the steam is sent to a steam turbine (not shown), which is a power generation part, to rotationally drive the steam turbine, and to rotationally drive a generator (not shown) connected to the steam turbine to generate electric power, whereby the power plant 1 is configured.

The solid fuel to be used is not limited to the present disclosure, and coal, biomass fuel, petroleum coke (PC), or the like can be used. Furthermore, the solid fuels may be used in combination.

As described above, the power plant 1 is configured by a large number of devices and has a complicated configuration, and the number of parts used in each device is enormous. Therefore, by applying the part management system 60, it is possible to appropriately perform maintenance of each device.

As described above, according to the part management system, the management system, the part management method, and the part management program according to the present embodiment, a remaining lifetime is estimated according to the use state of the target parts, and a quotation request is issued based on the remaining lifetime and a delivery period (a period required for delivery of the target parts). In this manner, it is possible to make a quotation in consideration of the delivery period. Accordingly, even a user who has difficulty in grasping a delivery period can perform a quotation request with sufficient time for the remaining lifetime, and it is possible to appropriately perform maintenance such as replacement of a target part.

For the user, the work such as the quotation request and the part configuration confirmation, which was complicated in the related art, is provided in a form organized in the electronic database by the part management system 60. Therefore, the part management becomes easier. For the manufacturer, the quotation and delivery work in a state where there is little remaining lifetime left or in a state where the remaining lifetime is exceeded is suppressed. Information is shared between both the user and the manufacturer, and the efficiency of part management is achieved.

The present disclosure is not limited to only the embodiments described above, and various modifications can be made within a scope which does not depart from the concept of the invention.

It is preferable that the part management system 60 is in cooperation with a system (a control system such as a DCS) on a user side and a system (a system such as a BOM) on a manufacturer side and that information is linked. For important data that should not be changed by a user or a manufacturer, it is desirable to provide a data diode function or the like to protect the flow of data in a one-way street.

In the part management function, a maintenance time of a part in storage may be managed. For example, by notifying the user of the time for reapplication of the rust preventive oil to the machined surface, the time for manually rotating the rotating part, or the like, sound storage management can be performed.

A link to an electronic part list may be provided from the part management function. That is, the user may be able to place an order for a spare part before the maintenance time arrives.

Regarding the quotation request function, it is desirable that the quotation request is output from all users in the same format. Further, it is desirable that the quotation request from the electronic part list is also in the same format.

For the quotation request function, a mechanism may be provided to regularly update the standard delivery period and the quotation period in the department in charge on the manufacturer side. Specifically, a mechanism may be adopted in which a rough quotation is issued to the manufacturer at any time and the quotation period or the delivery period is updated as a standard from the result.

The electronic part list may be provided with an “arrangement history”, a “favorite list (bookmark)”, a “related part recommendation function (recommendation) ”, or the like to improve convenience.

It is preferable that the electronic part list is configured to be able to request a quotation (arrangement) of even an assembly in addition to the parts. The configuration is not limited to the configuration of the drawings, and may be freely determined. In addition, for the set parts that are not sold as a single item, the single item purchase function may be eliminated and only the set may be selectable.

For example, in a case where the part is moved from the A mill to the B mill, the document management function may detect the movement with the RFID tag and the on-site receiver, and may reflect the detection result in the search result of the drawing.

As for the document management function, a link to a held document may be pasted to an appropriate location of another function, and a related document may be referable from another function.

For the input of the data analysis function, it is desirable that a link to the data and the operation time at the time of measurement are listed in a table format.

The output of the data analysis function may be, for example, a contour map (color map) of a 3D shape or a graph or the like. In addition, an output function in a report format may be provided.

The part management system, the management system, the part management method, and the part management program described in each of the embodiments described above are understood as follows, for example.

A part management system (60) according to the present disclosure includes a service life estimation unit (72) that estimates a remaining lifetime of a target part according to a use state of the target part, and a quotation request unit (62) that issues a quotation request for the target part, based on the remaining lifetime and a delivery period set in advance as a period required for delivery of the target part.

According to the part management system (60) according to the present disclosure, a remaining lifetime is estimated according to the use state of the target parts, and a quotation request is issued based on the remaining lifetime and a delivery period (a period required for delivery of the target parts). In this manner, it is possible to make a quotation in consideration of the delivery period. Accordingly, even a user who has difficulty in grasping a delivery period can perform a quotation request with sufficient time for the remaining lifetime, and it is possible to appropriately perform maintenance such as replacement of a target part. Therefore, it is possible to appropriately manage the part.

In the part management system (60) according to the present disclosure, the quotation request unit (62) may issue the quotation request in a case where the remaining lifetime is equal to or less than the delivery period.

According to the part £ management system (60) according to the present disclosure, a period for delivery period can be secured until the end of a service life, and it is possible to suppress a target part from being operated far beyond a service life.

In the part management system (60) according to the present disclosure, the quotation request unit (62) may issue the quotation request in a case where the remaining lifetime is equal to or less than a period obtained by adding the delivery period, a quotation period set in advance as a period required for creating a quotation, and an order placement period set in advance as a period for placing an order for the quotation.

According to the part management system (60) according to the present disclosure, it is possible to perform maintenance such as replacement of the target part more safely by securing the quotation period and the order placement period.

In the part management system (60) according to the present disclosure, the quotation request unit (62) may issue the quotation request in a time of a budget application time for a user of the target part, that is, in a case where a time obtained by subtracting, from the remaining lifetime, a period obtained by adding the delivery period, a quotation period set in advance as a period required for creating a quotation, and an order placement period set in advance as a period for placing an order for the quotation is earlier than a next budget application time.

According to the part management system (60) according to the present disclosure, since the quotation request can be performed in the time of the budget application time, it is easy to work to the budget. By setting the time obtained by subtracting, from the remaining lifetime, the period obtained by adding the delivery period, the quotation period, and the order placement period is earlier than the next budget application time, it is possible to issue a quotation in the budget application time close to the service life.

The part management system (60) according to the present disclosure may include a management unit (71) that manages information by associating the target part with at least one of product information, order information, location information, and time information, in which the product information may be at least one of a part name, a part number, a drawing number, and a revision number, the order information may be at least one of order content information and an order number, the location information may be at least one of a usage location and a storage location, and the time information may be at least one of a delivery time, a use start time, a storage start time, service life information, and delivery period information.

### According to the Part Management System (60)

according to the present disclosure, it is possible to manage the target part in detail. Target parts are associated with the respective pieces of information, so that the information can be efficiently organized.

The part management system (60) according to the present disclosure may include a provision unit (73) that provides information about a part being delivered, and a reception unit (74) that receives an order for the part, based on the provided information.

According to the part management system (60) according to the present disclosure, the information about the part related to the part being delivered is provided, and the order is received based on the provided information. In this manner, the part selection at the delivery destination can be facilitated.

In the part management system (60) according to the present disclosure, the information about the part provided by the provision unit (73) may be associated in a hierarchical order from a large configuration to a small configuration.

According to the part management system (60) according to the present disclosure, the information is associated in a hierarchical order, so that it is easier to search for the parts.

The part management system (60) according to the present disclosure may include a document storage unit (75) that stores electronic data of a document relating to a part being delivered, and a document provision unit (76) that provides, in response to a browsing request for the stored document, electronic data of the corresponding document.

According to the part management system (60) according to the present disclosure, the electronic data of the document relating to the part being delivered is stored, and the electronic data of the corresponding document is provided in response to the browsing request. In this manner, it is possible to improve convenience as compared with a case where the actual paper is used for the document.

The part management system (60) according to the present disclosure may include a service life analysis unit (77) that estimates the remaining lifetime of the target part, based on measurement data of the target part, in which the quotation request unit (62) may issue the quotation request for the target part, based on the remaining lifetime based on the measurement data and the delivery period.

According to the part management system (60) according to the present disclosure, the remaining lifetime is estimated based on the measurement data, and the quotation request is issued in consideration of the delivery period. In this manner, the quotation request can also be issued for the condition-based maintenance (CBM) part.

In the part management system (60) according to the present disclosure, the target part may be a spare part.

According to the part management system (60) according to the present disclosure, maintenance of the spare part can also be facilitated.

A part management system (60) according to the present disclosure includes a service life analysis unit (77) that estimates a remaining lifetime of a target part, based on measurement data of the target part, and a quotation request unit (62) that issues a quotation request for the target part, based on the remaining lifetime and a delivery period set in advance as a period required for delivery of the target part.

According to the part £ management system (60) according to the present disclosure, the remaining lifetime is estimated based on the measurement data, and the quotation request is issued in consideration of the delivery period. In this manner, the quotation request can also be issued for the condition-based maintenance (CBM) part.

A management system (70) according to the present disclosure includes an information processing terminal (53) that is connected to a network, and a server (52) that has a function of the above-described part management system (60) and performs communication with the information processing terminal (53) via the network.

According to the management system (70) according to the present disclosure, the server has the function of the part management system (60), so that the convenience of part management using the information processing terminal (53) can be improved.

A part management method according to the present disclosure includes a step of estimating a remaining lifetime of a target part according to a use state of the target part, and a step of issuing a quotation request for the target part, based on the remaining lifetime and a delivery period set in advance as a period required for delivery of the target part.

A part management method according to the present disclosure includes a step of estimating a remaining lifetime of a target part, based on measurement data of the target part, and a step of issuing a quotation request for the target part, based on the remaining lifetime and a delivery period set in advance as a period required for delivery of the target part.

A part management program according to the present disclosure causes a computer to execute a process of estimating a remaining lifetime of a target part according to a use state of the target part, and a process of issuing a quotation request for the target part, based on the remaining lifetime and a delivery period set in advance as a period required for delivery of the target part.

A part management program according to the present disclosure causes a computer to execute a process of estimating a remaining lifetime of a target part, based on measurement data of the target part, and a process of issuing a quotation request for the target part, based on the remaining lifetime and a delivery period set in advance as a period required for delivery of the target part.

A part management method according to the present disclosure includes a step of estimating a remaining lifetime of a target part of a user according to a use state of the target part, and a step of issuing a quotation request for the target part to a manufacturer of the target part, based on the remaining lifetime and a delivery period set in advance as a period required for delivery of the target part.

### REFERENCE SIGNS LIST

1: power plant
10: mill (pulverizing unit)
11: housing
12: pulverizing table
13: pulverizing roller
14: gear (drive transmission unit)
15: mill motor (drive part)
16: rotary classifier (classifying unit)
16a: blade
17: coal feed pipe (fuel feed unit)
18: classifier motor
19: outlet port
21: bunker (storage unit)
22: downspout part
25: coal feeder (fuel feeder)
26: transport unit
27: coal feeder motor
30: fan unit (carrier gas supply unit)
30a: hot gas flow path
30b: cold gas flow path
30c: hot gas damper
30d: cold gas damper
31: primary air fan (PAF)
32: forced draft fan (FDF)
33: induced draft fan (IDF)
34: air preheater (heat exchanger)
40: state detecting unit (temperature detecting unit, differential pressure detecting unit)
41: bottom face
42: ceiling
45: journal head
46: pressing device (pulverizing load application unit)
47: support arm
48: supporting shaft
50: control unit
52: server
53, 54: information processing terminal
60: part management system
61: part management unit
62: quotation request unit
63: electronic part list unit
64: document management unit
65: data analysis unit
70: management system
71: management unit
72: service life estimation unit
73: provision unit
74: reception unit
75: document storage unit
76: document provision unit
77: service life analysis unit
81: database
82: receiver
100: solid fuel pulverizing device
110: primary air channel (carrier gas channel)
120: pulverized fuel feed channel (pulverized fuel feed pipe)
200: boiler
210: furnace
220: burner (combustion equipment)
1100: CPU
1200: main memory
1300: storage unit
1400: external interface
1500: communication interface
1600: input unit
1700: display unit

1. A part management system comprising:
a service life estimation unit that estimates a remaining lifetime of a target part according to a use state of the target part; and
a quotation request unit that issues a quotation request for the target part, based on the remaining lifetime and a delivery period set in advance as a period required for delivery of the target part,
wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.

2. The part management system according to claim 1, wherein the quotation request unit issues the quotation request in a case where the remaining lifetime is equal to or less than the delivery period.

3. (canceled)

4. The part management system according to claim 1, wherein the quotation request unit issues the quotation request in a time of a budget application time for a user of the target part, that is, in a case where a time obtained by subtracting, from the remaining lifetime, a period obtained by adding the delivery period, a quotation period set in advance as a period required for creating a quotation, and an order placement period set in advance as a period for placing an order for the quotation is earlier than a next budget application time.

5. The part management system according to claim 1, further comprising:
a management unit that manages information by associating the target part with at least one of product information, order information, location information, and time information,
wherein the product information is at least one of a part name, a part number, a drawing number, and a revision number,
the order information is at least one of order content information and an order number,
the location information is at least one of a usage location and a storage location, and
the time information is at least one of a delivery time, a use start time, a storage start time, service life information, and delivery period information.

6. The part management system according to claim 1, further comprising:
a provision unit that provides information about a part being delivered; and
a reception unit that receives an order for the part, based on the provided information.

7. The part management system according to claim 6, wherein the information about the part provided by the provision unit is associated in a hierarchical order from a large configuration to a small configuration.

8. The part management system according to claim 1, further comprising:
a document storage unit that stores electronic data of a document relating to a part being delivered; and
a document provision unit that provides, in response to a browsing request for the stored document, electronic data of the corresponding document.

9. The part management system according to claim 1, comprising:
a service life analysis unit that estimates the remaining lifetime of the target part, based on measurement data of the target part,
wherein the quotation request unit issues the quotation request for the target part, based on the remaining lifetime based on the measurement data and the delivery period.

10. The part management system according to claim 1, wherein the target part is a spare part.

11. A part management system comprising:
a service life analysis unit that estimates a remaining lifetime of a target part, based on measurement data of the target part; and
a quotation request unit that issues a quotation request for the target part, based on the remaining lifetime and a delivery period set in advance as a period required for delivery of the target part,
wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.

12. A management system comprising:
an information processing terminal that is connected to a network; and
a server that has a function of the part management system according to claim 1 and performs communication with the information processing terminal via the network.

13. A part management method comprising:
a step of estimating a remaining lifetime of a target part according to a use state of the target part; and
a step of issuing a quotation request for the target part, based on the remaining lifetime and a delivery period set in advance as a period required for delivery of the target part,
wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.

14. A part management method comprising:
a step of estimating a remaining lifetime of a target part, based on measurement data of the target part; and
a step of issuing a quotation request for the target part, based on the remaining lifetime and a delivery period set in advance as a period required for delivery of the target part, wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.

15. A part management program causing a computer to execute:
a process of estimating a remaining lifetime of a target part according to a use state of the target part; and
a process of issuing a quotation request for the target part, based on the remaining lifetime and a delivery period set in advance as a period required for delivery of the target part,
wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.

16. A part management program causing a computer to execute:
a process of estimating a remaining lifetime of a target part, based on measurement data of the target part; and
a process of issuing a quotation request for the target part, based on the remaining lifetime and a delivery period set in advance as a period required for delivery of the target part,
wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.

17. A part management method comprising:
a step of estimating a remaining lifetime of a target part of a user according to a use state of the target part; and
a step of issuing a quotation request for the target part to a manufacturer of the target part, based on the remaining lifetime and a delivery period set in advance as a period required for delivery of the target part,
wherein the quotation request unit issues the quotation request in a case where the remaining lifetime is equal to or less than a period obtained by adding the delivery period, a quotation period set in advance as a period required for creating a quotation, and an order placement period set in advance as a period for placing an order for the quotation,
wherein the delivery period, the quotation period, and the order placement period are changed according to the business situation of the user or the manufacturer.
